(19) United States
(12) Patent Application Publication
(10) Pub. No.: US 2026/0050093 A1
(43) Pub. Date: Feb. 19, 2026

(54) COLLIMATOR, DETECTOR ASSEMBLY, AND COMPUTED TOMOGRAPHY IMAGING SYSTEM

(71) Applicant: GE Precision Healthcare LLC, Waukesha, WI (US)

(72) Inventor: Dongmei Wang, Beijing (CN)

(21) Appl. No.: 19/299,165

(22) Filed: Aug. 13, 2025

(30) Foreign Application Priority Data
Aug. 19, 2024 (CN) 202422010162.5

(51) Int. Cl. G01T 1/20

(52) U.S. Cl. CPC G01T 1/20185

(57) ABSTRACT

A computed tomography imaging system including a collimator and detector assembly are described herein. The collimator is coupled to the detector assembly, and includes a collimator module. The collimator module includes a plurality of first bases arranged at intervals, second bases located between every two first bases, and a plurality of first shielding plates located on the first bases. The width of the second bases is less than the width of the first bases, and the width of the first shielding plates is less than the width of the first bases.

### CROSS-REFERENCE TO RELATED APPLICATIONS

This application claims priority to Chinese Application No. 202422010162.5, filed on Aug. 19, 2024, the disclosure of which is incorporated herein by reference in its entirety.

### TECHNICAL FIELD

Embodiments of the present application relate to the field of medical devices, and relate in particular to a collimator, a detector assembly, and a computed tomography imaging system.

### BACKGROUND

A Computed Tomography (CT) system is an imaging technology. CT systems use X-rays to perform tomography on a human body, to generate detailed images of an internal structure of the body. A basic principle of CT scanning is to scan a slice of a specific thickness of a human body by using an X-ray beam. X-rays received by means of a detector change in intensity. These changing X-ray signals are converted into electrical signals, the electrical signals are converted into digital signals by means of an analog/digital converter, and the digital signals are input to a computer for processing.

In a CT imaging process, a selected slice is segmented into a number of small cubes of the same volume, i.e., voxels. An X-ray attenuation coefficient or absorption coefficient of each voxel is calculated by a computer, and arranged into a digital matrix. This digital matrix may be stored on a magnetic disk or an optical disk, and converted into pixels of different grayscales by means of a digital/analog converter, the pixels ultimately being arranged in a matrix to form a CT image. Therefore, the CT image is a reconstructed image, and the X-ray absorption coefficients of the voxels may be calculated by means of a mathematical method.

A detector is one of the core components of a CT system, and is also referred to as a CT detector. The detector mainly consists of a collimator or an anti-scatter grid (ASG), a scintillator, a photodiode, and an application specific integrated circuit (ASIC). An operating process of the CT detector is as follows: an X-ray enters the CT detector, the collimator blocks X-ray scattered light, a collimated X-ray passes through the scintillator and is converted from a high-energy X-ray into low-energy visible light, an optical signal is converted into an electrical signal by using the photodiode, and, finally, an electronic circuit performs analog-digital conversion and outputs a digital signal. To improve image resolution, the scintillator needs to be used together with the collimator, and the collimator is used to reduce scattered light, thereby avoiding impact on imaging quality.

It should be noted that the above introduction of the background is only for the convenience of clearly and completely describing the technical solutions of the present application, and for the convenience of understanding for those skilled in the art. The above technical solutions are not considered to be well known to those skilled in the art merely because they are set forth in the Background of the present application.

### SUMMARY

The inventors have found that dose is a very important parameter for a CT system, and a CT detector (referred to as a detector) generally uses “dose efficiency” to evaluate the dose of X-rays. Dose efficiency refers to efficiency of converting X-rays passing through a subject under examination by a detector system, and dose efficiency is usually evaluated by the detector system based on the ratio of the energy of X-rays emitted by an X-ray source (e.g., a bulb tube) to the energy received by the detector. To reduce costs, a collimator of the detector may use a 3D (three-dimensional) printed collimator. In addition, to ensure strength, the 3D printed collimator may be designed with a 2D (two-dimensional) flat panel, that is, the detector having shielding sheets (also referred to as shielding plates) only in an X direction and a Z direction, which means that an X plate (which is configured to separate X-rays radiated to the detector into units in the X direction or a channel direction, an extension direction of the units being parallel to the Z direction) and a Z plate (which is configured to separate the X-rays radiated to the detector into units in the Z direction or a slice direction, an extension direction of the units being parallel to the X direction) of the collimator also need to be designed as flat panels or grids. However, if the collimator has uniform and wide flat panels or grids of the X plate and Z plate, more useful X-rays passing through the subject under examination are shielded, resulting in poor dose efficiency.

To resolve at least one of the described problems or other similar problems, embodiments of the present application provide a collimator, a detector assembly, and a computed tomography imaging system, so as to balance high dose efficiency and good performance.

According to one aspect of the embodiments of the present application, provided is a collimator. The collimator is coupled to a detector assembly, and comprises a collimator module. The collimator module includes a plurality of first bases arranged at intervals, second bases located between every two first bases; and a plurality of first shielding plates located on the first bases. The width of the second bases is less than the width of the first bases, and the width of the first shielding plates is less than the width of the first bases. In some embodiments, the detector assembly comprises a plurality of scintillators, and the first bases and the second bases are each located above gaps between every two scintillators. In some embodiments, the first bases, the second bases, and the first shielding plates are disposed obliquely relative to the scintillators, and the first bases and the first shielding plates located thereon are inclined at the same angle. In some embodiments, the detector assembly is coupled to a computed tomography imaging system, the computed tomography imaging system comprising an X-ray source, and the plurality of first shielding plates being disposed facing the X-ray source. In some embodiments, projections of the first shielding plates fall on the first bases on which the first shielding plates are located, independent of an angle of the X-ray source relative to the collimator. In some embodiments, the collimator is a 3D printed collimator. In some embodiments, the width of the first bases is a specific size in a range of 0.18 millimeter to 0.26 millimeter, the width of the second bases is a specific size in a range of 0.18 millimeter to 0.22 millimeter, and the width of the first shielding plates is a specific size in a range of 0.05 millimeter to 0.1 millimeter.

According to another aspect of the embodiments of the present application, provided is a detector assembly. The detector assembly includes the collimator according to any one of the foregoing embodiments. According to yet another aspect of the embodiments of the present application, provided is a computed tomography imaging system. The computed tomography imaging system comprises the detector assembly according to the foregoing embodiments.

One of the beneficial effects of the embodiments of the present application is that: According to the embodiments of the present application, the first shielding plates (for example, Z plates) of the collimator of the detector assembly are arranged at intervals, and the first bases below the first shielding plates have a relatively large width, which is sufficient to cover shadows of the first shielding plates, so that operation performance can be ensured. In addition, a second base having a narrower width is disposed between two first bases, so that uniform performance of pixels when X-rays pass through can be ensured, which helps obtain higher dose efficiency.

With reference to the following description and drawings, specific implementations of the present application are disclosed in detail, and the means by which the principles of the present application can be employed are illustrated. It should be understood that the implementations of the present application are not limited in scope thereby. Within the scope of the clauses of the appended claims, the implementations of the present application comprise many changes, modifications, and equivalents.

The features described and/or illustrated for one implementation may be used in one or more other implementations in the same or similar way, be combined with features in other embodiments, or replace features in other implementations.

It should be emphasized that the term “include/comprise” when used herein refers to the presence of features, integrated components, steps or assemblies, but does not preclude the presence or addition of one or more other features, integrated components, steps or assemblies.

### BRIEF DESCRIPTION OF THE DRAWINGS

Elements and features described in one accompanying drawing or one implementation of the embodiments of the present application may be combined with elements and features shown in one or more other accompanying drawings or implementations. In addition, in the accompanying drawings, similar reference numerals represent corresponding components in several accompanying drawings, and may be used to indicate corresponding components that are used in more than one implementation.

The included accompanying drawings are used to provide further understanding of the embodiments of the present application, which constitute a part of the description and are used to illustrate the implementations of the present application and explain the principles of the present application together with textual description. Evidently, the accompanying drawings in the following description are merely some embodiments of the present application, and those of ordinary skill in the art may obtain other accompanying drawings according to these accompanying drawings without the exercise of inventive effort.

FIG. 1 is a schematic diagram of a CT imaging device according to an embodiment of the present application;

FIG. 2 is a schematic diagram of a CT imaging system according to an embodiment of the present application;

FIG. 3 is a schematic diagram of an example of a collimator module according to an embodiment of the present application;

FIG. 4 is a schematic diagram of a partial structure of the collimator module cut apart along an A-A direction shown in FIG. 3; and

FIG. 5 is a schematic diagram of observing the collimator module along a cross section shown in FIG. 4.

### DETAILED DESCRIPTION

The foregoing and other features of the present application will become apparent from the following description with reference to the accompanying drawings. In the description and accompanying drawings, specific implementations of the present application are disclosed in detail, and some implementations in which the principles of the present application may be employed are indicated. It should be understood that the present application is not limited to the described implementations, and on the contrary, the present application includes all modifications, variations, and equivalents which fall within the scope of the appended claims.

In the embodiments of the present application, the terms “first”, “second”, etc. are used to distinguish between different elements in terms of appellation, but do not represent a spatial arrangement, a temporal order, or the like of these elements, and these elements should not be limited by these terms. The term “and/or” includes any and all combinations of one or more associated listed terms. The terms “include”, “comprise”, “have”, etc. refer to the presence of described features, elements, components, or assemblies, but do not exclude the presence or addition of one or more other features, elements, components, or assemblies.

In the embodiments of the present application, the singular forms “a”, “the”, etc. may include plural forms, and should be broadly construed as “a type of” or “a class of” rather than being limited to the meaning of “one”. Furthermore, the term “the” should be construed as including both the singular and plural forms, unless otherwise specified in the context. In addition, the term “according to” should be construed as “at least in part according to . . . ” and the term “based on” should be construed as “based at least in part on . . . ”, unless otherwise specified in the context.

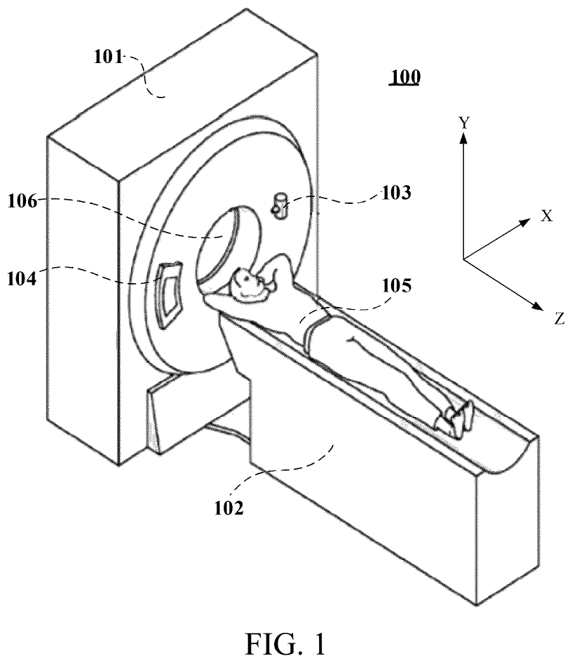

FIG. 1 is a schematic diagram of a CT imaging device according to an embodiment of the present application, and schematically shows a CT imaging device 100. Referring to FIG. 1, the CT imaging device 100 includes a scanning gantry 101 and a patient table 102. The scanning gantry 101 has an X-ray source 103, and the X-ray source 103 projects an X-ray beam toward a collimator or detector assembly 104 on the opposite side of the scanning gantry 101. A subject under examination 105 can lie flat on the patient table 102 and be moved into a scanning gantry opening 106 along with the patient table 102. Medical image data of the subject under examination 105 can be obtained by scanning performed by the X-ray source 103.

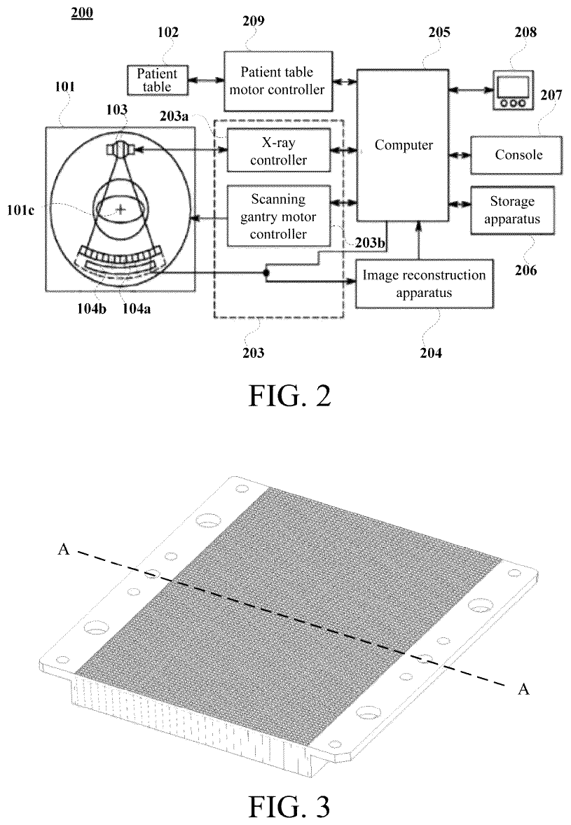

FIG. 2 is a schematic diagram of a CT imaging system according to an embodiment of the present application, and schematically shows a block diagram of a CT imaging system 200. As shown in FIG. 2, the detector assembly 104 includes a plurality of detector units 104a and a data acquisition system (DAS) 104b. The plurality of detector units 104a sense a projected X-ray passing through the subject under examination 105.

The DAS 104b, according to the sensing of the detector units 104a, converts collected information into projection data for subsequent processing. During the scanning for acquiring the X-ray projection data, the scanning gantry 101 and components mounted thereon rotate around a center of rotation 101c.

The rotation of the scanning gantry 101 and the operation of the X-ray source 103 are controlled by a control mechanism 203 of the CT imaging system 200. The control mechanism 203 includes an X-ray controller 203a that provides power and a timing signal to the X-ray source 103 and a scanning gantry motor controller 203b that controls the rotational speed and position of the scanning gantry 101. An image reconstruction apparatus 204 receives the projection data from the DAS 104b and performs image reconstruction. A reconstructed image is transmitted as an input to a computer 205, and the computer 205 stores the image in a mass storage apparatus 206.

The computer 205 also receives commands and scanning parameters from an operator by means of a console 207. The console 207 has an operator interface in a certain form, such as a keyboard, a mouse, a voice activated controller, or any other suitable input apparatus. An associated display 208 allows the operator to observe a reconstructed image and other data from the computer 205. The commands and parameters provided by the operator are used by the computer 205 to provide control signals and information to the DAS 104b, the X-ray controller 203a, and the scanning gantry motor controller 203b. Additionally, the computer 205 operates a patient table motor controller 209 which controls the patient table 102 so as to position the subject under examination 105 and the scanning gantry 101. In particular, the patient table 102 moves the subject under examination 105 to, fully or in part, pass through the scanning gantry opening 106 in FIG. 1.

Implementations of the present application are described below with reference to the accompanying drawings. In the following description, the X direction refers to a lateral direction of a CT imaging device, that is, a left-right direction of a subject under examination, which is also a channel direction of a detector; the Z direction refers to a longitudinal direction, that is, a direction in which the subject under examination enters or exits the CT imaging device, which is also a slice direction of the CT imaging device; and the Y direction refers to a radial direction of the CT imaging device, that is, a direction perpendicular to both the X direction and the Z direction. In addition, unless otherwise specified, “upper” and “lower” mean “upper” and “lower” in a gravity direction. FIG. 1 schematically shows the X direction, the Y direction, and the Z direction.

An embodiment of the present application provides a collimator, which is coupled to a detector assembly of a CT system. For example, the detector assembly is the CT detector, the detector assembly 104, or the like described above. The present application is not limited thereto, and the collimator may also be applied to another detector assembly in another field.

In an embodiment of the present application, the collimator is also referred to as an anti-scatter grid (ASG), and comprises a collimator module. The collimator module may be 3D printed, thereby reducing costs. In addition, the collimator module has characteristics of strong rigidity, thin wall thickness, high density, high absorption of scattered radiation, good shading, etc. However, the present application is not limited thereto, and the collimator module may alternatively be manufactured in another manner, provided that X-rays scattered and refracted from CT detection can be absorbed and filtered, to improve image contrast. In some embodiments, the collimator further includes another component other than the collimator module, for example, a support for supporting the collimator module. For details, reference may be made to the related art.

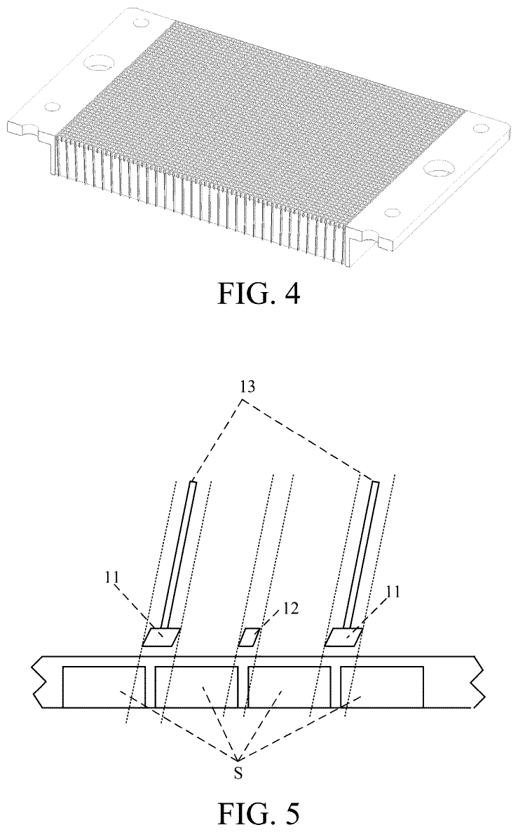

FIG. 3 is a schematic diagram of an example of a collimator module according to an embodiment of the present application; FIG. 4 is a schematic diagram of a partial structure of the collimator module cut apart along an A-A direction shown in FIG. 3; and FIG. 5 is a schematic diagram of observing the collimator module along a cross section shown in FIG. 4, schematically showing a basic configuration of the collimator module. In addition, FIG. 5 further schematically shows scintillators S.

As shown in FIG. 3 to FIG. 5, the collimator module in this embodiment of the present application comprises a plurality of first bases 11 arranged at intervals, second bases 12 located between every two first bases 11, and a plurality of first shielding plates 13 located on the first bases 11, the width of the second bases 12 being less than the width of the first bases 11, and the width of the first shielding plates 13 being less than the width of the first bases 11.

In the above embodiment, the first shielding plates 13 are, for example, Z plates of the collimator module (which are used to separate X-rays radiated to a detector into units in a Z direction or a slice direction, an extension direction of the units being parallel to an X direction). The Z plates of the collimator module are arranged at intervals, and first grids (that is, the first bases 11) are provided below the Z plates. The first grids may cover gaps between adjacent scintillators, and in addition, the first grids can cover shadows of the Z plates (that is, projections of the Z plates on the scintillators, wherein when a bulb tube is in cold and hot states, an X-ray emitting point moves, and when the emitting point is not completely aligned with the Z plates, shadows are formed on the scintillators, which are referred to as the shadows of the Z plates), thereby ensuring moving performance of the Z plates; that is, regardless of how the X-ray emitting point moves, the performance of the collimator module is not affected. In addition, second grids (the second bases 12) are provided between every two Z plates, and the second grids can ensure uniform performance of pixels when X-rays pass through, which helps obtain higher dose efficiency.

In the described embodiment, the width of the first grids (referred to as a first width) is greater than the width of the second grids (referred to as a second width); that is, the first grids are wider grids relative to the second grids, and the second grids are narrower grids relative to the first grids.

In an embodiment of the present application, as shown in FIG. 5, the detector assembly (for example, the CT detector) further comprises a plurality of scintillators S, and the first bases 11 and the second bases 12 are each located above gaps between two adjacent scintillators S. Thus, it can be ensured that X-rays do not fall into the gaps between the scintillators S, thereby improving imaging quality.

In the described embodiment, configurations and structures of the scintillators S are not limited, and a distance between two adjacent scintillators S (i.e., the width of the foregoing gaps, referred to as a third width) is not limited, provided that it can be ensured that the first bases 11 and the second bases 12 can shield X-rays from a bulb tube (X-ray source 103) of the CT system. For example, the first width and the second width are each greater than the third width.

In some embodiments, as shown in FIG. 5, the first bases 11, the second bases 12, and the first shielding plates 13 are disposed obliquely relative to the scintillators S, and the first bases 11 and the first shielding plates 13 located thereon are inclined at the same angle. Thus, it can be further ensured that the X-rays do not fall into the gaps between the scintillators S; that is, X-rays that may be radiated to the gaps between the scintillators S are shielded or absorbed, thereby improving the imaging quality.

In some embodiments, as previously described, the detector assembly is coupled to a computed tomography imaging system, such as the CT system shown in FIG. 2, the computed tomography imaging system comprising an X-ray source, such as the X-ray source 103 shown in FIG. 2, which is also referred to as a bulb tube. The plurality of first shielding plates 13 are disposed facing the X-ray source. Therefore, it can be further ensured that X-rays emitted by the X-ray source do not fall into the gaps between the scintillators S, thereby improving the imaging quality.

In the described embodiments, as the scanning gantry 101 rotates, the scanning assembly 104 also rotates, and the angle of the X-ray source relative to the collimator changes; regardless of how the angle of the X-ray source relative to the collimator changes, projections of the first shielding plates 13 fall on the first bases 11 on which the first shielding plates are located. That is, regardless of the angle of the X-ray source relative to the collimator, the projections of the first shielding plates 13 fall on the first bases 11 on which the first shielding plates are located. Thus, it can be further ensured that the X-rays emitted by the X-ray source do not fall into the gaps between the scintillators S, thereby improving imaging quality.

In some embodiments, the width of the first bases 11 (first width) may be set to a specific size in a range of 0.18 millimeter to 0.26 millimeter, the width of the second bases 12 (second width) may be set to a specific size in the range of 0.18 millimeter to 0.26 millimeter, and the width of the first shielding plates (i.e., the Z plates) is a specific size in a range of 0.05 millimeter to 0.1 millimeter, so that imaging quality can be ensured. For example, the width of the first bases is 0.23 millimeter, the width of the second bases is 0.2 millimeter, and the width of the first shielding plates is 0.08 millimeter.

It is worth noting that only the components or modules related to the present application have been described above, but the present application is not limited thereto. The collimator of the embodiments of the present application may further include another component or module, and various implementations that can be conceived of by those skilled in the art based on the above disclosure are included in the protection scope of the present application.

According to the described embodiments, the first shielding plates (for example, Z plates) of the collimator of the detector assembly are arranged at intervals, and the first bases below the first shielding plates have a relatively large width, which is sufficient to cover shadows of the first shielding plates, so that operation performance can be ensured. In addition, a second base having a narrower width is disposed between two first bases, so that uniform performance of pixels when X-rays pass through can be ensured, which helps obtain higher dose efficiency.

An embodiment of the present application further provides a detector assembly. The detector assembly comprises the collimator in the foregoing embodiments, and is, for example, the detector assembly 104 shown in FIG. 2, which may also be referred to as a CT detector. For other configurations and functions of the detector assembly, reference may be made to the description of FIG. 2, or reference may be made to the related art, and details are not described again here.

It can be learned from the described embodiments that the detector assembly in this embodiment of the present application includes the collimator in the foregoing embodiments, the first shielding plates (for example, Z plates) of the collimator are arranged at intervals, and the first bases below the first shielding plates have a relatively large width, which is sufficient to cover shadows of the first shielding plates, so that operation performance can be ensured. In addition, a second base having a narrower width is disposed between two first bases, so that uniform performance of pixels when X-rays pass through can be ensured, which helps obtain higher dose efficiency.

An embodiment of the present application further provides a computed tomography imaging system. The computed tomography imaging system comprises the detector assembly in the foregoing embodiments, for example, the CT imaging system shown in FIG. 2. For other configurations and functions of the CT imaging system, reference may be made to the description of FIG. 2, or reference may be made to the related art, and details are not described again here.

It can be learned from the described embodiments that the computed tomography imaging system in this embodiment of the present application uses the detector assembly in the foregoing embodiments, the detector assembly comprises the collimator in the foregoing embodiments, the first shielding plates (for example, Z plates) of the collimator are arranged at intervals, and the first bases below the first shielding plates have a relatively large width, which is sufficient to cover shadows of the first shielding plates, so that operation performance can be ensured. In addition, a second base having a narrower width is disposed between two first bases, so that uniform performance of pixels when X-rays pass through can be ensured, which helps obtain higher dose efficiency.

It is worth noting that only the components or modules related to the present application have been described above, but the present application is not limited thereto. The lifting bed in this embodiment of the present application may further include other components or modules, and for details of these components or modules, reference may be made to the related art.

1. A collimator, coupled to a detector assembly, and having a collimator module, wherein the collimator module comprises:
a plurality of first bases arranged at intervals;
second bases located between every two first bases; and
a plurality of first shielding plates located on the first bases;
wherein the width of the second bases is less than the width of the first bases, and the width of the first shielding plates is less than the width of the first bases.

2. The collimator according to claim 1, wherein the detector assembly comprises a plurality of scintillators, and the first bases and the second bases are each located above gaps between every two scintillators.

3. The collimator according to claim 2, wherein the first bases, the second bases, and the first shielding plates are disposed obliquely relative to the scintillators, and the first bases and the first shielding plates located thereon are inclined at the same angle.

4. The collimator according to claim 1, wherein the detector assembly is coupled to a computed tomography imaging system, the computed tomography imaging system comprising an X-ray source, and the plurality of first shielding plates being disposed facing the X-ray source.

5. The collimator according to claim 4, wherein projections of the first shielding plates fall on the first bases on which the first shielding plates are located, independent of an angle of the X-ray source relative to the collimator.

6. The collimator according to claim 1, wherein the collimator is a 3D printed collimator.

7. The collimator according to claim 1, wherein the width of the first bases is 0.23 millimeter, the width of the second bases is 0.2 millimeter, and the width of the first shielding plates is 0.08 millimeter.

8. A detector assembly, comprising:
a collimator, coupled to the detector assembly, and having a collimator module, wherein the collimator module includes:
a plurality of first bases arranged at intervals;
second bases located between every two first bases; and
a plurality of first shielding plates located on the first bases;
wherein the width of the second bases is less than the width of the first bases, and the width of the first shielding plates is less than the width of the first bases.

9. The detector assembly according to claim 8, further comprising a plurality of scintillators, and the first bases and the second bases are each located above gaps between every two scintillators.

10. The detector assembly according to claim 9, wherein the first bases, the second bases, and the first shielding plates are disposed obliquely relative to the scintillators, and the first bases and the first shielding plates located thereon are inclined at the same angle.

11. The detector assembly according to claim 8, wherein the detector assembly is coupled to a computed tomography imaging system, the computed tomography imaging system comprising an X-ray source, and the plurality of first shielding plates being disposed facing the X-ray source.

12. The detector assembly according to claim 11, wherein projections of the first shielding plates fall on the first bases on which the first shielding plates are located, independent of an angle of the X-ray source relative to the collimator.

13. The detector assembly according to claim 8, wherein the collimator is a 3D printed collimator.

14. The detector assembly according to claim 8, wherein the width of the first bases is 0.23 millimeter, the width of the second bases is 0.2 millimeter, and the width of the first shielding plates is 0.08 millimeter.

15. A computed tomography imaging system, comprising:
a detector assembly, wherein the detector assembly includes a collimator, coupled to the detector assembly, and having a collimator module, wherein the collimator module includes:
a plurality of first bases arranged at intervals;
second bases located between every two first bases; and
a plurality of first shielding plates located on the first bases;
wherein the width of the second bases is less than the width of the first bases, and the width of the first shielding plates is less than the width of the first bases.

16. The imaging system according to claim 15, wherein the detector assembly further comprises a plurality of scintillators, and the first bases and the second bases are each located above gaps between every two scintillators.

17. The imaging system according to claim 16, wherein the first bases, the second bases, and the first shielding plates are disposed obliquely relative to the scintillators, and the first bases and the first shielding plates located thereon are inclined at the same angle.

18. The imaging system according to claim 15, wherein the detector assembly is coupled to a computed tomography imaging system, the computed tomography imaging system comprising an X-ray source, and the plurality of first shielding plates being disposed facing the X-ray source.

19. The imaging systems according to claim 18, wherein projections of the first shielding plates fall on the first bases on which the first shielding plates are located, independent of an angle of the X-ray source relative to the collimator.

20. The imaging system according to claim 15, wherein the width of the first bases is 0.23 millimeter, the width of the second bases is 0.2 millimeter, and the width of the first shielding plates is 0.08 millimeter.
